(19) United States
(12) Patent Application Publication
(10) Pub. No.: US 2002/0163560 A1
(43) Pub. Date: Nov. 7, 2002

(54) Digital printing plate-making method and apparatus

(76) Inventors: Sadao Ohsawa, Shizuoka (JP); Yusuke Nakazawa, Shizuoka (JP); Kazuo Ishii, Shizuoka (JP); Eiichi Kato, Shizuoka (JP)

Correspondence Address: Sughrue Mion Zinn Macpeak & Seas PLLC, 2100 Pennsylvania Avenue N W, Washington, DC, 20037-3202, US

(21) Appl. No.: 09/538,967

(22) Filed: Mar. 31, 2000

(30) Foreign Application Priority Data
Mar. 31, 1999 (JP) HEI. 11-92885
Dec. 6, 1999 (JP) HEI.11-346323

(51) Int. Cl. B41J 2/06

(52) U.S. Cl. 347/55; 347/100; 347/102

(57) ABSTRACT

A plate-making method for forming an image based on signals of image data directly on a printing plate precursor by an ink jet recording method in which oil-based ink is ejected utilizing an electrostatic field and fixing the image, thereby preparing a printing plate. A plate-making apparatus of the invention includes an image former for forming an image based on signals of image data directly on a printing plate precursor and an image fixer for fixing the image formed by the image-former to prepare a printing plate, wherein the image-former is an ink jet recording device which ejects oil-based ink utilizing an electrostatic field from an ejection head.

### BACKGROUND OF THE INVENTION

1. Field of the Invention

The present invention relates to a digital plate-making method and apparatus. More particularly, the present invention relates to a digital plate-making method and apparatus in which oil-based ink is employed and which results in high quality images on both a lithographic printing plate and on prints.

2. Description of the Related Art

In the field of lithographic printing, ink receptive areas and ink repellent areas are formed on a surface of a printing plate in accordance with an original image. Printing ink adheres to the ink receptive areas. Ordinarily, hydrophilic areas and oleophilic areas are formed in image patterns on the surface of a printing plate, and the hydrophilic areas become oil-based ink repellent areas by applying dampering water thereto.

Conventional image formation on a printing plate is carried out by exposing a silver halide photographic film with the desired image in an analog or digital manner, exposing a photosensitive material (printing plate precursor) containing a diazo resin or a photopolymerizable polymer through the silver halide photographic film, and removing the photosensitive material by dissolving out the non-image areas. This removal process is carried out mainly by using an alkaline solution.

With recent improvements in digital recording technology and the demand for more efficient printing processes, various methods wherein digital image information is directly recorded on a printing plate precursor have been proposed. These methods include technologies referred to as a CTP (computer-to-plate) method and a DDPP (digital direct printing plate) method. These methods typically involve an image recording system having a photon-mode or heating mode using a laser beam. After the image is recorded on a plate using either the photon mode or the heating mode, the non-imaged areas are dissolved out by treating the plate with an alkaline developer. This method results in an alkaline waste liquid discharge, which is environmentally undesirable.

Also, the conventional methods require the use of large and expensive laser beam apparatuses. It has therefore been attempted to develop a system utilizing an ink jet recording method using an inexpensive and compact recording device.

A method wherein plate-making is performed by recording an image on a hydrophilic surface of a printing plate precursor by an ink jet recording method using oleophilic wax ink is described in JP-A-64-27953. (The term “JP-A” as used herein means an unexamined published Japanese patent application.) In this method, stability of the ink ejection is good and removal of the image portion after completion of printing is not necessary because the printing plate is disposable. However, since the image is formed using wax, the mechanical strength of the image portion is low and the adhesion of the image portion to the hydrophilic surface of the printing plate precursor is poor. The printing durability (press life) of the resulting printing plate is therefore insufficient.

### SUMMARY OF THE INVENTION

It is an object of the present invention to overcome the problems described above. Specifically, it is an object of the present invention to provide a plate-making method and apparatus for use with a digital recording system which does not require chemical development or other such processing.

It is another object of the present invention to provide a plate-making method and apparatus for producing a lithographic printing plate capable of providing a large number of prints having images of high quality in a simple and inexpensive manner.

The above and other objects of the present invention are accomplished by a plate-making method including the steps of forming an image based on image data signals directly on a printing plate precursor using an ink jet recording method in which oil-based ink is ejected utilizing an electrostatic field and fixing the image.

The oil-based ink is preferably a dispersion containing hydrophobic resin particles which are solid at least at ordinary temperature dispersed in a nonaqueous solvent having an electrical specific resistance of 10⁹-cm or more and a dielectric constant of 3.5 or less.

The above and other objects of the present invention are also accomplished by a plate-making apparatus comprising an image-former for forming an image based on signals of image data directly on a printing plate precursor and an image-fixer for fixing the image formed by the image-former to prepare a printing plate, wherein the image-former is an ink jet recording device which ejects oil-based ink from an ejection head utilizing an electrostatic field.

In this case also the oil-based ink is a dispersion comprising hydrophobic resin particles which are solid at least at ordinary temperature and which are dispersed in a nonaqueous solvent having an electrical specific resistance of 10⁹-cm or more and a dielectric constant of 3.5 or less.

The image-former has a heater using a heated roller and/or an infrared lamp, a halogen lamp or a xenon flash lamp. The heater is arranged and/or controlled so as to gradually increase the temperature of the printing plate precursor at the time of fixing the image.

In this plate-making apparatus, rotation of a drum on which the printing plate precursor is mounted effects the main scanning for forming the image on the printing plate precursor. The ejection head may have either a single-channel head or a multiple-channel head, and the ejection head can be moved in the axial direction of the drum to conduct the subsidiary scanning for forming the image on the printing plate precursor. Otherwise, transportation of the printing plate precursor by holding with at least one pair of capstan rollers can be employed to effect the subsidiary scanning for forming the image on the printing plate precursor.

The ejection head may be either a single-channel head or a multiple-channel head, and the ejection head is moved in the direction perpendicular to the direction of transportation of the printing plate precursor to conduct the main scanning for forming the image on the printing plate precursor.

The ejection head may be a full-line head having a length which is approximately equal to the width of the printing plate precursor.

The ink jet recording device may further include an ink supplier for supplying the oil-based ink to the ejection head, as well as an ink recoverer which recovers the oil-based ink from the ejection head so as to re-circulate the ink.

The apparatus may further be provided with a dust remover for removing dust from the surface of the printing plate precursor before and/or during formation of the image on the printing plate precursor.

Also, the ink jet recording device may further include a stirrer which stirs the oil-based ink in an ink tank housing the oil-based ink.

Still further, the ink jet recording device may be provided with an ink temperature controller for controlling the temperature of the oil-based ink in an ink tank housing the oil-based ink.

Advantageously, the ink jet recording device may be provided with an ink concentration controller which controls the concentration of the oil-based ink.

Yet further, the apparatus may include a cleaner which cleans the ejection head.

### BRIEF DESCRIPTION OF THE DRAWINGS

FIG. 1 is a schematic side view showing an example of a plate-making apparatus of the present invention.

FIG. 2 is a schematic side view showing another example of a plate-making apparatus of the present invention.

FIG. 3 is a schematic side view showing an example of a recording portion of a plate-making apparatus of the present invention.

FIG. 4 is a schematic perspective view showing an example of an ejection head installed in an ink jet recording device of the present invention.

FIG. 5 is a cross-sectional view illustrating the ink ejection area of the ejection head shown in FIG. 4.

FIG. 6 is a cross-sectional view illustrating an ink ejector of another example of an ejection head which is installed in an ink jet recording device of the present invention.

FIG. 7 is a front view of the ink ejector shown in FIG. 6.

FIG. 8 is a schematic perspective view showing a main portion of still another example of an ejection head that is installed in an ink jet recording device of the present invention.

FIG. 9 is a schematic perspective view of the ejection head of FIG. 8 from which regulating panels are removed.

FIG. 10 is a schematic perspective view showing a main portion of still another example of an ejection head installed in an ink jet recording device of the present invention.

### DESCRIPTION OF THE PREFERRED EMBODIMENTS

Preferred embodiments of a plate-making apparatus for use in the plate-making method of the present invention are described below.

The present invention is characterized in that image formation is carried out by an ink jet recording method in which oil-based ink is ejected utilizing an electrostatic field onto a plate material (printing plate precursor).

In the present invention, the size of the ejected ink droplets is determined by the size of the tip of the ejection electrode or the application condition of the applied electric field. When the ejection electrode is small in size or the application condition of the electric field is appropriately controlled, minute ink droplets can be formed without reducing the ejection nozzle diameter or the ejection slit width. Image control can therefore be accomplished without the ink clogging in the head. As a result, the plate-making method and apparatus according to the present invention produce a printing plate capable of providing a large number of prints of clear images.

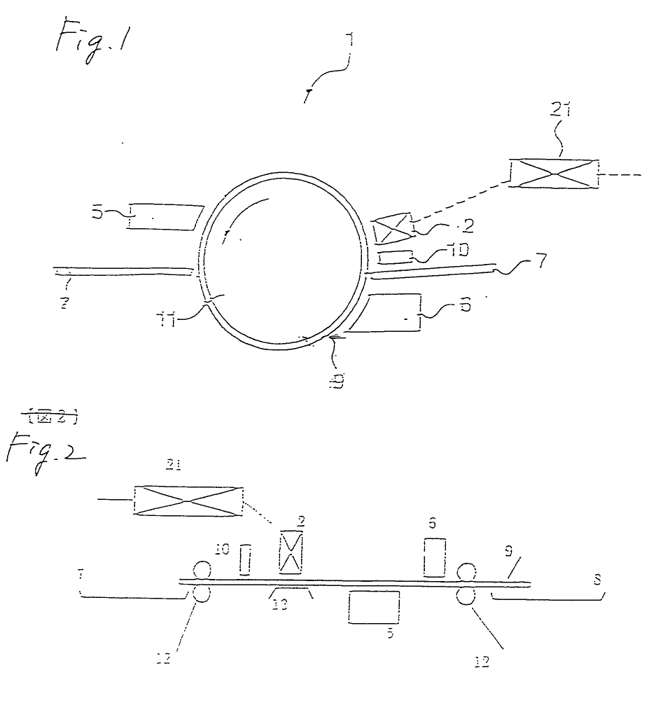

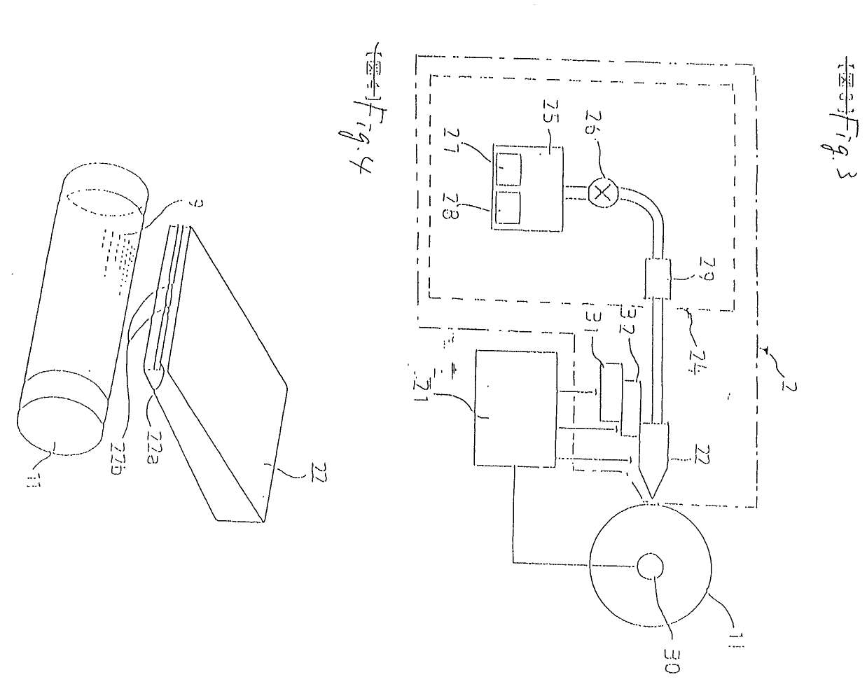

FIGS. 1 and 2 show plate-making apparatuses. FIG. 3 shows an example of the recording portion including a controller, an ink supplier and a mechanism for moving a head toward or away in the plate-making apparatus. FIGS. 4 to 10 each illustrate an ink jet recording device installed in the plate-making apparatus shown in either of FIGS. 1 and 2.

While the plate-making method according to the present invention is described with reference to a plate-making apparatus in which a printing plate precursor is provided on a drum 11 for recording as shown in FIG. 1, the invention should not be construed as being limited thereto.

The drum 11 is ordinarily made of metal (e.g., aluminum, stainless steel or steel), plastic or glass. When using a drum made of metal, the surface thereof is usually subjected to an alumite (anodic oxidation) treatment or chromium plating for the purpose of increasing abrasion resistance and preventing rust. The drum 11 may have a heat insulator on its surface as described below. Further, it is preferable for the drum 11 to be grounded because the drum acts as a counterelectrode to an electrode of the ejection head 22 during ejection under an electrostatic field. If the substrate of the printing plate precursor is a good insulator, it is preferable to provide a conductive layer on the substrate of the precursor and for the conductive layer to be grounded. In a case where a heat insulator is provided on the drum 11 as described above, recording is more easily accomplished by providing the printing plate precursor with a ground. Examples of a ground include a known conductive brush, leaf spring and roller.

The plate-making apparatus 1 also has an ink jet recording device 2 which ejects oil-based ink onto the printing plate precursor 9 mounted on the drum 11. The ink is ejected in accordance with image data transmitted from an arithmetic and control unit 21, to thereby form an image on the printing plate precursor.

Further, the plate-making apparatus 1 is provided with a fixing device 5 for adhering the oil-based ink image formed on the printing plate precursor 9. Additionally, a plate surface oil-desensitizing device 6 may be installed depending on the type of printing plate precursor 9 for increasing the hydrophilic property of the surface of the printing plate precursor 9. The plate-making apparatus 1 also has a dust remover 10 for removing dust present on the printing plate precursor surface before and/or during the process of recording the image on the printing plate precursor 9. The dust remover can effectively prevent ink from adhering to the printing plate precursor 9 via dust settling between the ejection head 22 and the printing plate precursor 9 during the plate-making process. Examples of the dust remover include a contact method using a brush or a roller, in addition to a conventional non-contact method involving suction, blowing or electrostaticity. The removal method is preferably one that uses suction, blowing or a combination thereof.

An automatic plate material supplying device 7, by which the printing plate precursor 9 is fed automatically to the drum 11, and an automatic plate material discharging device 8, by which the printing plate precursor 9 is removed from the drum 11 after the image-forming operation, may be installed. The use of the automatic plate material supplying device 7 and the automatic plate material discharging device 8 can make the plate-making operation simpler and shorter, so that the effects of the present invention can be further enhanced.

A method of preparing a printing plate using the plate-making apparatus 1 is described below with reference to FIG. 1 and a portion of FIG. 3.

The printing plate precursor 9 is first mounted on the drum 11 using the automatic plate material supplying device 7. The printing plate precursor 9 is brought into close contact with and fixed firmly to the drum 11 by means of a well-known mechanical device such as a plate head/end gripping device or an air suction device, or by a well-known electrostatic device. Due to this firm fixation, the end of the plate precursor 9 is prevented from flapping against and damaging the ink jet recording device 2 during the recording process. Also, it is possible to prevent the printing plate precursor 9 from scraping against the ink jet recording device by using an arranger which brings the printing plate precursor into close contact with the drum only in the neighborhood of the recording position of the ink jet recording device. Specifically, the arranger may be, for example, hold-down rollers disposed on both upstream and downstream sides of the recording position of the drum 11. Further, the ejection head 22 should be kept away from the printing plate precursor 9 when the image-formation operation is suspended so as to effectively prevent the occurrence of scraping and undesirable damage to the ink jet recording device 2.

The arithmetic and control unit 21 receives image data from, e.g., an image scanner, a magnetic disk device or an image data communication device, and not only carries out color separation, if desired, but also processing of the separated data into appropriate numbers of pixels and gradations. In addition to these operations, the control unit 21 calculates dot area percentage in order to enable the recording of oil-based ink images in halftone dots by means of an ejection head 22 (see FIG. 3 explained in detail hereinafter) with which the ink jet recording device 2 is equipped. Furthermore, as described below, the arithmetic and control unit 21 controls the movement of ejection head 22 and the time at which the oil-based ink is ejected and, if desired, the timing of the rotation of the drum 11.

The arithmetic data input to the arithmetic and control unit 21 is temporarily stored in a buffer. The arithmetic and control unit 21 instructs the rotation of the drum 11 and, at the same time, switches on an ejection head moving device 31 which moves the ejection head 22 towards or away from the drum 11. The distance between the ejection head 22 and the surface of the printing plate precursor 9 mounted on the drum 11 is maintained during recording at a desired value by mechanical distance control, e.g., using a contact roller or by controlling the ejection head moving device 31 in accordance with signals from an optical distance detector. Such distance control makes it possible to prevent irregularities in dot diameter due to looseness of the printing plate precursor. Such distance control also ensures no change in dot diameter even when the plate-making apparatus is subjected to vibration. Thus, satisfactory plate making can be accomplished.

For the ejection head 22, a single-channel head, a multiple-channel head, or a full-line head can be used. Main scanning is carried out by rotating the drum 11. In the case of a multiple-channel head or full-line head having a plurality of ejectors, the head is arranged so that the ejectors are aligned the axial direction of the drum 11. In the case of a single- or multiple-channel head, according to instructions from the arithmetic and control unit 21, the head is moved in the direction parallel to the axis of rotation every time the drum 11 rotates. Oil-based ink is ejected from the head towards the printing plate precursor 9 mounted on the drum 11 at a position and with the dot area percentage determined by operations performed by the control unit 21. As a result, a dot image with gradations corresponding to the original is recorded with the oil-based ink on the printing plate precursor 9. These operations are continued until the oil-based ink image corresponding to one-color information of the original is formed on the printing plate precursor to prepare a printing plate. In the case of a full-line head having substantially the same length as the width of the drum 11, on the other hand, an oil-based ink image corresponding to one-color information of the original is formed on the printing plate precursor 9 during one rotation of the drum 11 to prepare a printing plate. As described above, the drum 11 is rotated to effect main scanning so that positional precision in the main scanning direction is enhanced and high-speed recording becomes feasible.

Subsequently, the ejection head 22 is moved away from the position close to the drum 11 in order to protect the ejection head 22. When the operation of image formation is completed, the device for moving the head towards and away operates so as to keep the ejection head at least 500 μm away from the drum. This movement may be effected using a sliding system or a mechanism by which the ejection head 22 is gripped with an arm fixed on a shaft and moved in a pendulum-like motion by turning the shaft. By keeping the ejection head 22 away from the drum 11 when image formation is not being carried out, the head 22 is protected from physical damage and contamination. As a result, the life of the head 22 can be extended.

The oil-based ink image formed by the head 22 is hardened with a fixing device 5. Well-known fixing techniques, such as heat fixing and solvent fixing, can be employed for fixing the ink image. In the case of heat fixing, irradiation with an infrared lamp, a halogen lamp or a xenon flash lamp, hot air fixing using a heater, or fixing using a heated roller can be used. In such a case, for increasing the fixing efficiency measures may be adopted such as previously heating the drum, previously heating the printing plate precursor, performing the recording under exposure to hot air, using a drum coated with a heat insulator, or heating the printing plate precursor alone by separating the printing plate precursor from the drum only at the time of fixing. These measures may be employed in combination of two or more thereof. Flash fixing using, e.g., a xenon lamp, is well-known as a fixing method for electrophotographic toner, and has the advantage of performing the fixing in a short time.

In case of using a printing plate precursor having a paper substrate, moisture present inside the printing plate precursor quickly evaporates due to a rapid rise of temperature by the heating, hence irregularities such as blistering can occur on the surface of printing plate precursor. Therefore, in order to gradually increase the temperature of a printing plate precursor having a paper substrate, it is preferred to gradually increase the electric power supply while rotating the drum 11, or to gradually change the rotational speed of the drum 11 from a high speed to a low speed while maintaining the electric power supply constant. In order to gradually increase the temperature of a printing plate precursor having a paper substrate, it is also preferred that a plurality of heating devices are disposed in the rotation direction of the drum 11, with the distance from the printing plate precursor 9 and/or electric power supply thereto appropriately controlled.

In the case of solvent fixing, a solvent capable of dissolving the resin component of the ink, such as methanol or ethyl acetate, is sprayed onto the printing plate precursor, or the printing plate precursor is exposed to vapor of the solvent, and the excess solvent vapor is recovered.

It is desirable, at least during the portion of the process from formation of the oil-based ink image by means of the ejection head 22 to the fixing of the image with the fixing device 5, for the image on the printing plate precursor 9 to be prevented from coming into contact with any external object.

A preferred embodiment of a plate-making apparatus in which transport of the printing plate precursor effects subsidiary scanning for forming an image is described with reference to FIG. 2, but the present invention should not be construed as being limited thereto.

The printing plate precursor 9 is held between two pairs of capstan rollers 12 and is transported and recorded on using an ink jet recording device 2. The recording is based on data obtained by the arithmetic and control unit 21 processing image data into appropriate numbers of pixels and gradations.

It is preferred to provide in the vicinity of the recording position of the ink jet recording device 2 a ground 13 which acts as a counterelectrode to the electrodes of the ejection head 22 for the electrostatic ejection operation in order to easily conduct the recording. On the other hand, if the substrate of the printing plate precursor 9 is highly insulating, it is preferred to provide a conductive layer on the substrate. In this case, the conductive layer is desirably grounded by means of a known conductive brush, leaf spring or roller.

Although a plate-making apparatus using a sheet of the printing plate precursor is shown in FIG. 2, the printing plate precursor 9 can also be employed suitably in roll form. In such a case, it is desirable to provide a sheet cutter on the upstream side of the automatic plate material discharging device.

The plate-making apparatus 1 also has an ink jet recording device 2 which ejects oil-based ink onto the printing plate precursor in accordance with the image data transmitted from the arithmetic and control unit 21, thereby forming an image on the printing plate precursor.

Further, the plate-making apparatus 1 is provided with a fixing device 5 for firmly adhering the oil-based ink image formed on the printing plate precursor 9. In addition, if desired, a plate surface oil-desensitizing device 6 may be installed, depending on the type of printing plate precursor 9 employed, for increasing the hydrophilic property of the surface of the printing plate precursor 9. In addition to these devices, the plate-making apparatus 1 has a dust remover 10 for removing dust present on the printing plate precursor surface before and/or during recording the image on the printing plate precursor 9. The dust remover can effectively prevent the ink from adhering to the printing plate precursor 9 via the dust particles present between the ejection head 22 and the printing plate precursor 9 in the course of plate-making, and as a result, more satisfactory plate-making can be accomplished. Examples of the dust- remover include a contact method using a brush or a roller, in addition to a conventional non-contact method such as removal by suction, removal by blowing air, or electrostatic removal. Removal by air suction, removal by blowing with air, or a combination thereof is preferably used in the present invention.

Further, an automatic plate material supplying device 7, by which the printing plate precursor 9 is fed automatically, and an automatic plate material discharging device 8, by which the printing plate precursor 9 after the image-forming operation is removed, may be provided. The use of the automatic plate material supplying device/and the automatic plate material discharging device 8 can make the plate-making operation simpler and the plate-making time shorter so that the effects of the present invention can be further enhanced.

A method of preparing a printing plate using the plate-making apparatus 1 is described below with reference to FIG. 2 and a portion of FIG. 3.

First, the printing plate precursor 9 is transported using an automatic plate material supplying device 7 and capstan rollers 12. A structure for guiding plate material (not shown) is provided, if desired, in order to prevent the head and/or end of plate material from hitting against the ink jet recording device 2 and causing damage during recording. Also, it is possible to prevent the printing plate precursor from scraping against the ink jet recording device by arranging a device for preventing the printing plate precursor from becoming loose only in the vicinity of the recording position of the ink jet recording device and activating this device at least during the recording operation. Specifically, the device may include hold-down rollers disposed on both upstream and downstream sides of the recording position. Further, it is desired for the ejection head 22 to keep away from the printing plate precursor 9 when the image-formation operation is completed in order to effectively prevent the occurrence of damage to the ink jet recording device 2 due to scraping and the like.

Image data from, e.g., a magnetic disk device are fed to the arithmetic and control unit 21, and therein the operations for determining the ejection positions of oil-based ink and the dot area percentages at the respective positions are performed in accordance with the input image data. The resulting arithmetic data are temporarily stored in a buffer.

The arithmetic and control unit 21 controls the movement of the ejection head 22, the time at which the oil-based ink is ejected, and the time at which the capstan rollers are operated, and, if desired, the timing of activation of an ejection head moving device 31 which moves the ejection head 22 towards or away from the printing plate precursor 9.

The distance between the ejection head 22 and the surface of the printing plate precursor 9 is kept at the desired value during the recording by mechanical distance control, e.g., using a contact roller, or by controlling the ejection head moving device which moves the ejection head in accordance with signals from an optical distance detector. Such a distance control device makes it possible to prevent irregularities in dot diameter due to looseness of the printing plate precursor. In particular, the distance control device can ensure a constant dot diameter, even if the plate-making apparatus is subjected to vibration. Thus, satisfactory plate-making can be accomplished.

For the ejection head 22, a single-channel head, a multiple-channel head or a full-line head can be used. Subsidiary scanning is carried out by the transportation of the printing plate precursor 9. In the case of a multiple-channel head having a plurality of ejectors, the head is arranged so that these ejectors are aligned approximately parallel to the direction of transportation of the printing plate precursor. In the case of a single- or multiple-channel head, according to the instructions from the arithmetic and control unit 21, the head is moved in a direction perpendicular to the direction of transportation of the printing plate precursor every time the printing plate precursor moves. Oil-based ink is ejected from the head towards the printing plate precursor 9 at positions and with dot area percentages determined by the operations performed by the control unit 21. As a result, a dot image corresponding to gradations of the original is recorded with the oil-based ink on the printing plate precursor 9.

These operations are continued until an oil-based ink image corresponding to one-color information of the original is formed on the printing plate precursor to prepare a printing plate. In the case of a full-line head having substantially the same length as the width of the printing plate precursor 9, on the other hand, the head is arranged so that the ejectors are aligned approximately perpendicular to the direction of transportation of the printing plate precursor. The oil-based ink image corresponding to one-color information of the original is formed on the printing plate precursor 9 by passing the printing plate precursor 9 past the recording position to prepare a printing plate.

Subsequently, the ejection head 22 is preferably moved away from the position close to the printing plate precursor 9 in order to protect the ejection head. While the operation of image formation is completed, the device for moving the head towards and away is operated so as to keep the ejection head at least 500 μm away from the printing plate precursor 9. The movement may be effected with a sliding system or with a device by which the ejection head is gripped with an arm fixed on a shaft and moved in a pendulum-like manner by turning the shaft. By keeping the ejection head away from the drum when the image formation has been completed, the head is protected from physical damage and contamination. As a result, the life of the head can be extended.

Further, the oil-based ink image so formed is hardened with a fixing device 5. Well-known fixing techniques, e.g., heat fixing and solvent fixing, can be employed for fixing the ink image. In the case of heat fixing, irradiation with an infrared lamp, a halogen lamp or a xenon flash lamp, hot air fixing using a heater, or heated roller fixing is ordinarily carried out. Flash fixing using, e.g., a xenon lamp, which is a known fixing method for electrophotographic toner, has the advantage of performing the fixing in a short time.

In case of using a printing plate precursor having paper as a substrate, moisture present inside the printing plate precursor will suddenly evaporate upon a rapid rise of temperature by the heating, and irregularities such as blistering can occur on the surface of the printing plate precursor. Therefore, in order to gradually increase the temperature of printing plate precursor having a paper substrate, it is preferred that a plurality of heating devices are provided, and that the distance from the printing plate precursor 9 and/or the power supply of electrical power thereto are appropriately controlled in such a manner as to prevent the occurrence of blistering.

In the case of solvent fixing, a solvent capable of dissolving the resin component of the ink such as methanol or ethyl acetate is sprayed onto the printing plate precursor, or the printing plate precursor is exposed to vapor of the solvent and the excess solvent vapor is recovered.

It is desirable that, at least during the portion of the process from the formation of an oil-based ink image by means of the ejection head 22 to the fixing with the fixing device 5, the image on the printing plate precursor 9 is maintained out of contact with any other object.

The printing plate thus prepared is subjected to printing in a manner well-known in lithographic printing. More specifically, the printing plate having the oil-based ink image formed thereon is mounted on a plate cylinder of a printing machine and printing ink and dampening water are applied thereto, thereby forming a printing ink image. The printing ink image thus formed is transferred onto a blanket cylinder rotating in concert with the plate cylinder, and then the printing ink image on the blanket cylinder is transferred to printing paper passing between the blanket cylinder and an impression cylinder to conduct printing corresponding to one-color information of the original. After the printing operation, the printing plate is removed from the plate cylinder, and a blanket on the blanket cylinder is cleaned with a blanket cleaning device to be restored to a printable state.

The ink jet recording device 2 is described in more detail below.

The ink jet recording device 2 used in the plate-making apparatus of the present invention includes an ejection head 22 and an ink supplier 24, as shown in FIG. 3. The ink supplier 24 has an ink tank 25, an ink supplying device 26 and an ink concentration controlling device 29. The ink tank 25 is furnished with a stirrer 27 and an ink temperature controlling device 28. The ink may be circulated through the ejection head 22. In this case, the ink supplier 24 has a recovering function in addition to the circulatory function. The stirrer 27 inhibits the solid component of the ink from precipitating and aggregating so as to reduce the necessity for cleaning the ink tank 25. Examples of the ink stirrer include a rotating blade, an ultrasonic vibrator and a circulatory pump. These tools can be used alone or in combination. The ink temperature controlling device 28 is arranged so as to prevent the physical properties of the ink from changing due to change in ambient temperature, thereby ensuring no changes in dot diameter so as to form a consistently high-quality image. To control the ink temperature, a well-known method can be adopted. More specifically, the ink tank can be provided with a heating element such as a heater or a Peltie element or a cooling element together with the stirrer 27 so as to make the temperature distribution inside the ink tank uniform, and the temperature is controlled with a temperature sensor such as thermostat. It is desirable that the ink temperature inside the ink tank be from 15° C. to 60° C., and preferably from 20° C. to 50° C. The stirrer may be used for both purposes of keeping the temperature distribution uniform and for preventing precipitation and aggregation of the solid component of the ink.

For achieving high-quality image formation, it is preferred that the plate-making apparatus of the present invention further be provided with an ink concentration controlling device 29. This device makes it possible to effectively prevent blurring on the printing plate precursor and blank portions in the printed image due to a decrease of solid concentration in the ink or changes of dot diameter due to increase of the solid concentration in the ink. Ink concentration control is carried out by optical detection, measurement of physical properties such as electric conductivity or viscosity, or monitoring a number of printing plate precursors subjected to image formation. More specifically, the ink concentration is controlled by feeding concentrated ink from an ink tank for replenishment (not shown) or a diluent from an ink carrier tank for dilution (not shown) in accordance with output signals from an optical detector, a conductivity measuring instrument and a viscosity measuring instrument provided individually or in combination inside the ink tank 25, or ink flow course in the case of control in accordance with measurements of physical properties, or based on a number of printing plates made or a frequency of plate-making operations in the case of monitoring the number of printing plate precursors subjected to image formation.

The arithmetic and control unit 21, as described above, not only performs arithmetical operations on input image data and controls movement of the ejection head 22 with the ejection head moving device 31 or the head subsidiary scanner 32, but also receives a timing pulse from an encoder 30 attached to the drum 11 or capstan rollers and carries out operation of the ejection head 22 in accordance with the timing pulse. As a result, positional precision is improved.

The ejection head 22 will now be described in more detail with reference to FIGS. 4 to 10. However, the present invention should not be construed as being limited thereto.

FIGS. 4 and 5 show an example of an ejection head which is installed in the ink jet recording device. The ejection head 22 has a slit interposed between an upper unit 221 and a lower unit 222, each formed by an insulating substrate, while the tip thereof forms an ejection slit 22a. An ejection electrode 22b is arranged in the slit, and the slit is filled with oil-based ink 23 supplied from an ink supplying device. Examples of the insulating substrate usable for the head include plastics, glass and ceramics. The ejection electrode 22b is formed on the lower unit 222 made of an insulating substrate according to a known method. For instance, the top surface of the lower unit 222 may be provided with a conductive material such as aluminum, nickel, chromium, gold or platinum using a technique such as vacuum deposition, sputtering or electroless plating, and then the conductive material coating is covered with a photoresist. The photoresist is exposed to light via a desired electrode pattern and developed to form a photoresist pattern in the form of the ejection electrode 22b. Then, the conductive material coating undergoes etching, mechanical removal or a combination thereof to form the ejection electrode 22b.

During operation of the ejection head 22, a voltage is applied to the ejection electrode 22b in accordance with digital signals corresponding to image pattern information. As shown in FIG. 4, the ejection electrode 22b is arranged facing the drum 11 so as to constitute a counterelectrode, and the printing plate precursor 9 is mounted on the drum as the counterelectrode. Upon application of voltage, a circuit is formed between the ejection electrode 22b and the drum 11 acting as the counterelectrode, and the oil-based ink 23 is ejected from the ejection slit 22a of the ejection head 22 to form an image on the printing plate precursor 9 mounted on the drum 11 as the counterelectrode.

In order to form a high-quality image, it is preferred that the tip of the ejection electrode 22b is made as small as possible. The tip of the electrode is ordinarily shaped so as to have a width of from 5 to 100 μm, although the tip width may be varied depending on conditions such as the applied voltage or physical properties of the ink used.

For instance, a dot having a diameter of 40 μm can be formed on the printing plate precursor 9 when an ejection electrode 22b having a tip width of 20 μm is used, the space between the ejection electrode 22b and the drum 11 as a counterelectrode is adjusted to 1.0 mm, and a voltage of 3 kV is applied for 0.1 millisecond between these electrodes.

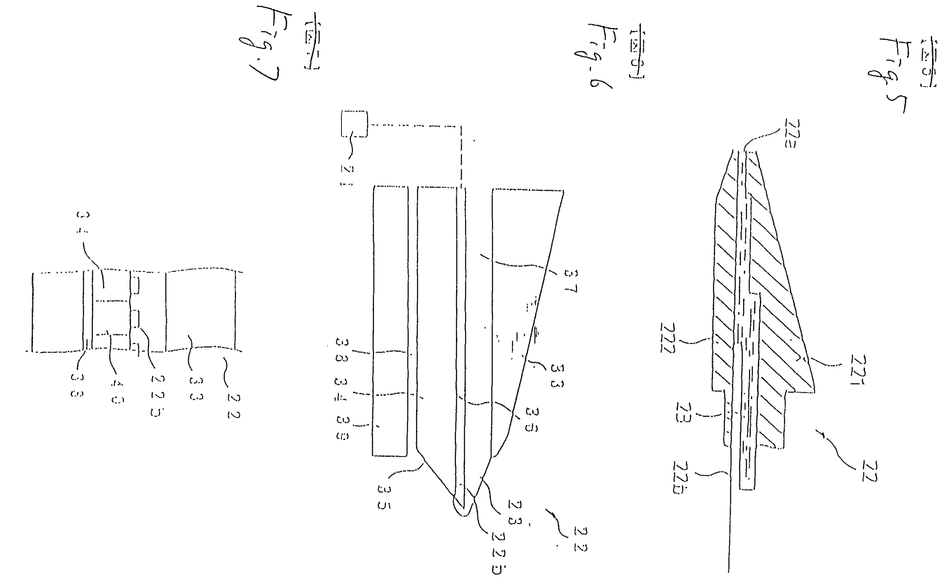

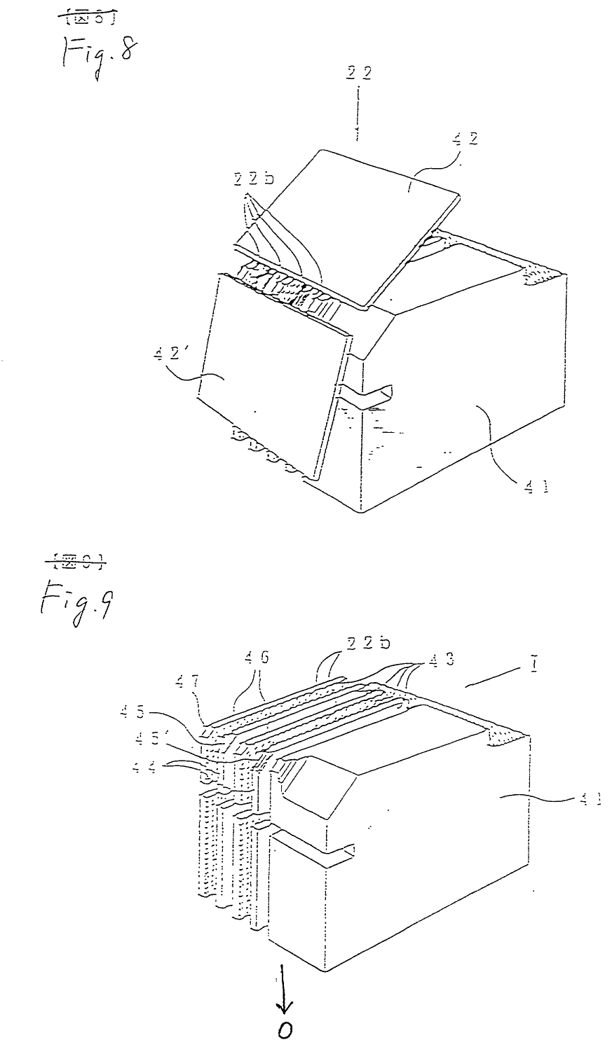

FIGS. 6 and 7 respectively show a cross-sectional view and a front view of the vicinity of an ink ejector of another example of the ejection head. Reference numeral 22 in these figures indicate the ejection head. The head has a first insulating substrate 33 of a tapered shape. A second insulating substrate 34 is set facing to and apart from the first insulating substrate 33. An end portion of the second insulating substrate 34 has a slope 35. The first and second insulating substrates are each made of, e.g., plastics, glass or ceramics. On a top surface 36 of the second insulating substrate 34, which makes a sharp-angle with the slope 35, a plurality of ejection electrodes 22b are provided for forming an electrostatic field in the ejector. The tips of the ejection electrodes 22b extend to the vicinity of the tip of the top surface 36, and protrude beyond the tip of the first insulating substrate 33, thereby forming the ejectors. An ink inflow course 37, defining a pathway for supplying ink 23 to the ejector, is formed between the first and second insulating substrates 33 and 34, and the ink recovery course 38 is formed on the underside of the second insulating substrate 34. The ejection electrodes 22b are formed using a conductive material such as aluminum, nickel, chromium, gold or platinum on the top surface of the second insulating substrate 34 in a conventional manner as described above. The respective ejection electrodes 22b are constructed so as to be in an electrically insulated state.

A suitable length for the tip of the ejection electrodes 22b that protrude beyond the tip of the first insulating substrate 33 is 2 mm or less. A reason why such a range of protrusion is preferred is that, if the protrusion is too long, it is difficult for the ink meniscus to reach the tip of ejector, resulting in difficulty in ejection of the ink and a decrease in maximum recording frequency. Also, it is preferred that the space between the first and second insulating substrate 33 and 34 be from 0.1 to 3 mm. A reason why this range is preferred for the space is that too narrow a space makes supply of the ink difficult, resulting in difficulty in ejection of the ink and a decrease in maximum recording frequency while, on the other hand, too wide a space makes the meniscus unstable, resulting in inconsistent ejection of the ink.

The ejection electrode 22b is connected to the arithmetic and control unit 21. In carrying out recording, a voltage is applied to the ejection electrode in accordance with image information signals from the arithmetic and control unit 21, and thereby the ink on the ejection electrode is ejected to perform image formation on a printing plate precursor (not shown) arranged to be facing to the ejector. The ink inflow course 37 is connected to a device for sending ink from an ink supplying device (not shown) on the side opposite to the ink ejector. Further, a backing 39 is arranged apart from and facing toward the underside, which is the reverse of the ejection electrode side, of the second insulating substrate 34 to form an ink recovery course 38 between the backing and the underside of the second insulating substrate 34. It is preferred that the width of the space of the ink recovery course 38 be at least 0.1 mm. This is because too small a space makes the recovery of ink difficult, resulting in ink leakage. The ink recovery course 38 is connected to an ink recoverer, which is attached to the ink supplying device (not shown).

If a uniform ink flow over the ejector is required, grooves 40 may be provided between the ejector and the ink recoverer. FIG. 7 is a front view showing the vicinity of the ejector of an ejection head. As shown in FIG. 7, a plurality of grooves 40 are provided in the slope of the second insulating substrate 34 from the vicinity of the borders with the respective ejection electrodes 22 to the ink recovery course 38. The grooves 40 are aligned in the lengthwise direction of the ink jet electrode 22b, and have a function for conducting by capillary action a predetermined amount of ink, depending on the opening diameter, present in the vicinity of the tip of each ejection electrode from the respective openings on the side of ejection electrodes 22b into the ink recovery course 38. Thus, the grooves 40 function to form an ink flow having a certain thickness in the vicinity of the tip of each ink jet electrode. The groove 40 may have any shape as far as the grooves can provide the desired capillary action. However, it is especially desirable that the width of the grooves is from 10 to 200 μm and the depth thereof is from 10 to 300 μm. The grooves 40 are provided in a number sufficient for forming a uniform ink flow over the entire ejection head.

In order to form a high-quality image, it is preferred that the tip of the ejection electrode 22b be made as small as possible. The tip of the electrode is ordinarily shaped so as to have a width of from 5 to 100 μm, although the tip width may be varied depending on conditions such as the applied voltage or physical properties of the ink.

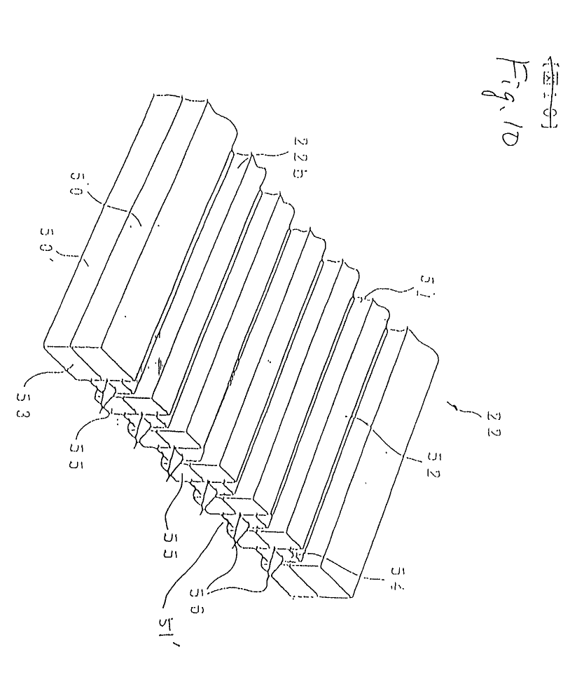

Still another example of the ejection head for use in the present invention is shown in FIGS. 8 and 9. FIG. 8 is a view showing only a portion of the head. The ejection head 22, as shown in FIG. 8, has a main body 41 made of an insulating material such as plastics, ceramics or glass, and meniscus regulating panels 42 and 42′. Reference numeral 22b in FIG. 8 indicates an ejection electrode to which a voltage is applied to form an electrostatic field in the ejector. The main body 41 of the head is further illustrated in detail with reference to FIG. 9 wherein the regulating panels 42 and 42′ are removed from the ejection head.

The main body 41 of the head has a plurality of ink grooves 43 cut perpendicularly to the edge thereof for the purpose of ink circulation. The grooves 43 each may have any shape so far as the grooves can provide a suitable capillary action sufficient to form a uniform ink flow. However, it is especially desirable that the width of the groove be from 10 to 200 μm and the depth thereof be from 10 to 300 μm. Ejection electrodes 22b are provided in respective ones of the grooves 43. In each of the grooves 43 the ejection electrode 22b may be arranged so as to cover the entire surface of the groove or it may be formed on only a portion of the groove using a conductive material such as aluminum, nickel, chromium, gold or platinum, according to a well-known method as described in the above-described example of the head. Additionally, the ejection electrodes are electrically isolated from one another. Two ink grooves adjacent to each other form one cell, and a separator wall 44 positioned in the center of the cell has an ejector 45 or 45′ in the tip. The separator wall 44 is made thinner in the ejector 45 or 45′ than in other portions thereof, and the ejector is sharpened. The main body of the head having the configuration as described above is formed using a conventional method such as mechanical processing or etching of a block of insulating material, or molding of an insulating material. It is desirable that the separator wall in the ejector have a thickness of from 5 to 100 μm and the sharpened tip thereof have a radius of curvature of from 5 to 50 μm. Further, the tip of the ejector may be slightly cut off as shown in the ejector 45′. In the figure, only two cells are depicted for ease of illustration.

A separator wall 46 is disposed between cells. The tip 47 of the wall 46 is cut off so as to be set back compared with the ejectors 45 and 45′. The ink is flowed into the ejection head via ink grooves from the direction indicated by an arrow I from an ink supplying device (not shown), and thereby supplied to the ejectors. Further, the excess ink flowed in the direction O is recovered with an ink recoverer (not shown). As a result, fresh ink is always supplied to each ejector. A drum holding a printing plate precursor on the surface thereof (not shown) is arranged so as to face the ejector. While maintaining such a condition, a voltage corresponding to the image information is applied to the ejection electrode, and ink is ejected from the ejector to form an image on the printing plate precursor.

Still another example of the ejection head is described with reference to FIG. 10. As shown in FIG. 10, the ejection head 22 has a pair of nearly rectangular plate-shaped support members 50 and 50′. Each of these support members 50 and 50′is made of an insulating plastic, glass or ceramic plate having a thickness of from 1 to 10 mm, and in one surface thereof there are formed a plurality of rectangular grooves 51 or 51′ extending parallel to one another. Each of the grooves 51 and 51′ desirably has a width of from 10 to 200 μm and a depth of from 10 to 300 μm. In each of the grooves, an ejection electrode 22b is formed so as to cover the whole or only a portion of the groove surface. The formation of a plurality of grooves 51 or 51′ in one surface of each support member 50 or 50′ results in the formation of rectangular separator walls 52 between respective pairs of grooves. The support members 50 and 50′ are placed together so that the surfaces thereof in which no grooves are formed are brought into contact with each other. Specifically, the ejection head 22 has a plurality of grooves for distribution of ink over the periphery thereof. The grooves 51 formed in the support member 50 are coupled to corresponding ones of the grooves 51′ formed in the support member 50′ by way of the rectangular portion 54 of the ejection head 22. Each rectangular portion 54 that couples together two corresponding grooves is set back a predetermined distance (e.g., 50 to 500 μm) from the top end portion 53 of the ejection head. In other words, each of the separator walls 52 adjoining each rectangular portion 54 on both sides is disposed so that the top end 55 thereof protrudes beyond the adjacent rectangular portions 54. Also, a guide protrusion 56 made of an insulating material as described above is attached so as to protrude beyond each rectangular portion 54, thereby forming the ejector.

When ink is circulated through the ejection head 22 having the structure as described above, the ink is supplied to each rectangular portion 54 via a respective groove 51 formed at the periphery of the support member 50, and the ink is discharged via the grooves 51′ formed in the support member 50′ opposite the support member 50. In this case, the ejection head 22 is inclined at a predetermined angle in order to enable smooth ink circulation. Specifically, the ejection head 22 is inclined so that the ink supply side of the support member 50 is situated upward and the ink discharge side of the support member 50′ is situated downward. By circulating the ink through the ejection head 22 in such a manner, the ink passing across each rectangular portion 54 flows forward along the guide protrusions 56 to form an ink meniscus in the vicinity of the rectangular portion 54 and the protrusion 56. A drum holding a printing plate precursor on the surface thereof (not shown) is arranged so as to face the ejector. With independent ink meniscuses formed on the respective rectangular portions 54, a voltage corresponding to the image information is applied to the ejection electrode, and the ink is ejected from the ejector to form an image on the printing plate precursor.

A cover may be attached along the periphery of each of the support members 50 and 50′ to cover the grooves, thereby forming pipe-shaped ink flow courses along the periphery of each of the support members 50 and 50′ . In such a case, since the ink can be made to circulate by way of these ink flow courses, it is not necessary to incline the ejection head 22.

The ejection heads as shown in FIG. 4 to FIG. 10 can also be provided with a maintenance device such as a cleaner if desired. For instance, in a case where recording has been suspended for a certain period or problems in image quality occur, a device for wiping the tip of the ejection head with a flexible brush or cloth, a device for circulating the ink solvent alone, and a device for exerting suction on the ejector while supplying or circulating the ink solvent alone can be adopted alone or in combination, whereby satisfactory recording conditions can be maintained. In order to prevent the ink from solidifying inside the ejection head, it is also effective to cool the ejection head, thereby reducing evaporation of the ink solvent. Further, if the contamination of the head is severe, a method of suctioning ink from the ejector, a method of blowing air in the ink flow course, and a method of applying ultrasonic waves to the head while immersing the head in an ink solvent are also effective. These methods can be used alone or in combination.

The plate material of the printing plate precursor which can be used in the present invention will be described in greater detail below.

A metal plate such as an aluminum plate or a steel plate plated with chromium is usually employed as the printing plate precursor. An aluminum plate subjected to a graining and anodizing treatment is particularly preferred because of the excellent water-retention and anti-abrasion properties of the surface thereof. Also, from an economic standpoint, a printing plate precursor having a water-resistant support such as paper subjected to a water-resistant treatment, a plastic film or paper laminated with plastic, having provided thereon an image-receiving layer can be employed. The thickness of the printing plate precursor is ordinarily in a range of from 100 to 300 μm, and the thickness of the image-receiving layer is ordinarily in a range of from 5 to 30 μm.

The image-receiving layer includes a hydrophilic layer including an inorganic pigment and a binder and a layer capable of being rendered hydrophilic by an oil-desensitizing treatment.

The inorganic pigment used in the hydrophilic image-receiving layer includes clay, silica, calcium carbonate, zinc oxide, aluminum oxide and barium sulfate. The binder used includes a hydrophilic binder, for example, polyvinyl alcohol, starch, carboxymethyl cellulose, hydroxyethyl cellulose, casein, gelatin, a salt of polyacrylic acid, polyvinyl pyrrolidone and a methyl ether-maleic anhydride copolymer. Further, in order to impart water-resistance to the image-receiving layer, a melamine formaldehyde resin, a urea formaldehyde resin or other crosslinking agents may be added-thereto if desired.

The image-receiving layer to which an oil-desensitizing treatment is applied includes, for example, a layer containing zinc oxide and a hydrophobic binder.

The zinc oxide used in the image-receiving layer according to the present invention is any of zinc oxide, zinc white, wet-type zinc white, and activated zinc white as commercially available, as described in Nippon Ganryo Gijutsu Kyokai, ed., “Shinban Ganryo Binran (New Edition of Pigment Handbook)”, pp. 319, Kabushiki Kaisha Seibundo (1968).

Specifically, depending on the starting materials and production method, zinc oxide is classified into two groups, that produced by a wet method and that produced by a dry method, which groups are further subclassified into zinc oxide produced by the “French” method (indirect method) or “American” method (direct method).

Suitable examples of zinc oxide include those commercially available from Seido Kagaku Kogyo K.K., Sakai Chemical Industry Co., Ltd., Hakusui Chemical Industries, Ltd., Honjo Chemical K.K., Toho Zinc Co., Ltd., and Mitsui Mining & Smelting Co., Ltd.

A resin suitable for the hydrophobic binder includes a styrene copolymer, a methacrylate copolymer, an acrylate copolymer, a vinyl acetate copolymer, polyvinyl butyral, an alkyd resin, an epoxy resin, an epoxy ester resin, a polyester resin and a polyurethane resin. The resins may be employed individually or as a mixture of two or more thereof.

A content of the resin in the image-receiving layer is from 9/91 to 20/80 in terms of a weight ratio of resin/zinc oxide.

The oil-desensitizing treatment of the image-receiving layer containing zinc oxide is conducted using an oil-desensitizing solution in a conventional manner. Suitable examples of the oil-desensitizing solution include those conventionally known, for example, a treating solution containing a cyan compound such as ferrocyanate or ferricyanate as the main component, a cyan-free treating solution containing an ammine cobalt complex, phytic acid or a derivative thereof, or a guanidine derivative as the main component, a treating solution containing an inorganic or organic acid capable of forming a chelate with an zinc ion as the main component, and a treating solution containing a water-soluble polymer.

For instance, treating solutions containing a cyan compound include those described, e.g., in JP-B-44-9045, JP-B-46-39403, JP-A-52-76101, JP-A-57-107889 and JP-A-54-117201. (The term “JP-B” as used herein means an examined Japanese patent publication.)

It is preferred that the back surface of the printing plate precursor opposite to the image-receiving layer have a Bekk smoothness in a range of from 150 to 700 (sec/10 ml). Such a printing plate can be firmly mounted on a plate cylinder of a printing machine and does not cause shearing or slippage during printing to perform satisfactory printing.

The Bekk smoothness can be measured by a Bekk smoothness tester. The Bekk smoothness tester is a tester for measuring the time required for a definite volume (10 ml) of air to pass between a test piece and a glass surface under a reduced pressure, wherein the test piece is pressed to a highly smoothly finished circular glass plate having a hole at its center while applying thereto a definite pressure (1 kgf/cm², i.e., 9.8 N/cm²).

The oil-based ink which can be used in the present invention is described in more detail below.

The oil-based ink used in the present invention is a dispersion comprising hydrophobic resin particles which are solid at least at ordinary temperature (i.e., 15° C. to 35° C.) dispersed in a nonaqueous solvent, preferably having an electrical specific resistance of 10⁹ Ω-cm or more and a dielectric constant of 3.5 or less.

Preferred examples of the nonaqueous solvent having an electrical specific resistance of 10⁹ Ω-cm or more and a dielectric constant of 3.5 or less include straight-chain or branched aliphatic hydrocarbons, alicyclic hydrocarbons, aromatic hydrocarbons and halogenated products of these hydrocarbons. Specific examples thereof include hexane, heptane, octane, isooctane, decane, isodecane, decaline, nonane, dodecane, isododecane, cyclohexane, cyclooctane, cyclodecane, benzene, toluene, xylene, mesitylene, Isopar C, Isopar E, Isopar G, Isopar H and Isopar L (Isopar: tradename, a product of Exxon Corp.), Shellsol 70 and Shellsol 71 (Shellsol: tradename, product of Shell Oil Corp.), Amsco OMS and Amsco 460 solvent (Amusco: tradename, product of American Mineral Spirits Corp.), and silicone oils. They can be used individually or as a mixture of two or more thereof. As to the nonaqueous solvent, the upper limit of the electrical specific resistance value is of the order of 10¹⁶ Ω-cm, and the lower limit of the dielectric constant value is about 1.9.

The reason why the range of the nonaqueous solvent is restricted as described above is explained below. If the electrical resistance of the nonaqueous-solvent used is too far below the above-described range, generation of agglomerations of the resin particles and the like in the ink scarcely occurs, so that sufficient printing durability of a printing plate is not attained. On the other hand, when the dielectric constant of the nonaqueous solvent used is too far above the above-described range, the electrostatic field is apt to be relaxed due to polarization of the solvent, and thereby poor ejection of the ink tends to occur.

The resin particles dispersed in the nonaqueous solvent as described above are hydrophobic resin particles which are solid at temperature of 35° C. or less and have good affinity with the nonaqueous solvent. As such a hydrophobic resin, a resin (P) having a glass transition temperature of from −5° C. to 110° C. or a softening temperature of from 33° C. to 140° C. is preferred. The more preferable range of the glass transition temperature is from 10° C. to 100° C., and that of the softening temperature is from 38° C. to 120° C. In particular, it is preferred for the resin (P) to have a glass transition temperature of from 15° C. to 80° C. or a softening temperature of from 38° C. to 100° C.

By using a resin having such a glass transition temperature or a softening temperature as described above, the affinity of each resin particle with the image-receiving surface of the printing plate precursor is enhanced and the resin particles are firmly bonded with each other on the printing plate precursor. Thus, the adhesion of the ink image to the printing plate precursor is increased and the press life is improved. On the contrary, if the glass transition temperature or a softening temperature of the resin used is beyond the upper and lower limits specified above, the affinity of each resin particle with the image-receiving surface of the printing plate precursor may be lowered and the bond between resin particles may be weakened.

The weight average molecular weight (Mw) of the resin (P) is preferably from 1×10³ to 1×10⁶, more preferably from 5×10³ to 8×10⁵, and still more preferably from 1×10⁴ to 5×10⁵.

Examples of such a resin (P) include olefin homopolymers and copolymers (such as polyethylene, polypropylene, polyisobutylene, ethylene-vinyl acetate copolymer, ethylene-acrylate copolymer, ethylene-methacrylate copolymer and ethylene-methacrylic acid copolymer), vinyl chloride homopolymers or copolymers (such as polyvinyl chloride and vinyl chloride-vinyl acetate copolymer), vinylidene chloride copolymers, vinyl alkanoate homopolymers and copolymers, allyl alkanoate homopolymers and copolymers, homopolymers and copolymers of styrene and derivatives thereof (such as butadiene-styrene copolymer, isoprene-styrene copolymer, styrene-methacrylate copolymer and styrene-acrylate copolymer), acrylonitrile copolymers, methacrylonitrile copolymers, alkyl vinyl ether copolymers, acrylate homopolymers and copolymers, methacrylate homopolymers and copolymers, itaconic acid diester homopolymers and copolymers, maleic anhydride copolymers, acrylamide copolymers, methacrylamide copolymers, phenol resins, alkyd resins, polycarbonate resins, ketone resins, polyester resins, silicone resins, amide resins, hydroxyl and carboxyl-modified polyester resins, butyral resins, polyvinyl acetal resins, urethane resins, rosin resins, hydrogenated rosin resins, petroleum resins, hydrogenated petroleum resins, maleic acid resins, terpene resins, hydrogenated terpene resins, chroman-indene resins, cyclized rubber-methacrylate copolymers, cyclized rubber-acrylate copolymers, copolymers containing a heterocyclic ring containing no nitrogen atom (as the heterocyclic ring, e.g., furan ring, tetrahydrofuran ring, thiophene ring, dioxane ring, dioxofuran ring, lactone ring, benzofuran ring, benzothiophene ring and 1,3-dioxetane ring), and epoxy resins.

It is desirable for the resin particles to be contained in the oil-based ink in an amount of from 0.5 to 20% by weight based on the total ink content. If the amount of the resin particles is too low, the affinity of the ink with the surface of the printing plate precursor is insufficient, and, as a result, the ink may not form images of good quality and the press life tends to decrease. On the other hand, if the proportion of resin particles is increased beyond the above-described range, it may be difficult to form a homogeneous dispersion, and, as a result, the ink flow is apt to become irregular and stable ink ejection may not be achieved.

For the oil-based ink used in the present invention, it is preferred to include a coloring material together with the resin particles in order to allow easy visual inspection of the resulting printing plate. Such a coloring material may be any of a number of pigments and dyes which have been ordinarily used in conventional oil-based ink compositions and liquid developers for electrostatic photography.

The pigment to be used has no particular restriction, and includes both inorganic and organic pigments which are ordinarily used in the field of printing. Examples of pigments usable in the oil-based ink include carbon black, cadmium red, molybdenum red, chrome yellow, cadmium yellow, titanium yellow, chromium oxide, viridian, cobalt green, ultramarine blue, Prussian blue, cobalt blue, azo pigments, phthalocyanine pigments, quinacridone pigments, isoindolinone pigments, dioxazine pigments, threne pigments, perylene pigments, perynone pigments, thioindigo pigments, quinophthalone pigments, metal complex pigments, and other conventionally known pigments.

As the dyes, oil-soluble dyes are suitable for use in the oil-based ink, with examples including azo dyes, metal complex dyes, naphthol dyes, anthraquinone dyes, indigo dyes, carbonium dyes, quinoneimine dyes, xanthene dyes, cyanine dyes, quinoline dyes, nitro dyes, nitroso dyes, benzoquinone dyes, naphthoquinone dyes, phthalocyanine dyes and metallo-phthalocyanine dyes.

The pigments and dyes may be used individually, or they can be used in appropriate combinations. It is desirable that they are contained in a proportion of from 0.01 to 5% by weight based on the total ink content.

Such a coloring material as described above may be dispersed in the nonaqueous solvent as dispersed particles separately from the resin particles, or it may be incorporated into the resin particles dispersed in the nonaqueous solvent. In the latter case, the incorporation of a pigment is ordinarily effected by coating the pigment with the resin material of resin particles to form resin-coated particles, while the incorporation of a dye is ordinarily effected by coloring the surface portion of resin particles with the dye to form colored particles.

The average diameter of the resin particles, including colored particles, dispersed in the nonaqueous solvent is preferably from 0.05 to 5 μm, more preferably from 0.1 to 1.0 μm. The diameter of the particles is determined with a particle size analyzer, CAPA-500 (tradename, manufactured by Horiba Ltd.).

The nonaqueous dispersion of resin particles used in the present invention can be prepared using a well-known mechanical grinding method or a polymerization granulation method. In the mechanical grinding method, the materials for forming resin particles are mixed, molten and kneaded, if required, and directly ground into fine particles with a conventional grinder, and further dispersed in the presence of a dispersing polymer by means of a conventional wet-type dispersing machine (e.g., a ball mill, a paint shaker, a Keddy mill, a Dyno mill). In another mechanical grinding method, the materials for forming resin particles and a dispersion assisting polymer (a covering polymer) are kneaded in advance to form a kneaded matter, then ground into fine particles, and further dispersed in the presence of a dispersing polymer. Methods of preparing paints or liquid developers for electrostatic photography can be adopted in practice. Details of these methods are described, e.g., in Flow of Paints and Dispersion of Pigments, translated under the supervision of Kenji Ueki, Kyoritsu Shuppan (1971), Solomon, Paint Science, Hirokawa Shoten (1969), Yuji Harasaki, Coating Engineering, Asakura Shoten (1971), and Yuji Harasaki, Elementary Course of Coating Science, Maki Shoten (1977).

For the polymerization granulation method, well-known methods for dispersion polymerization in nonaqueous media can be employed. Details of such methods are described, e.g., in The Newest Technology of Super-Fine Polymer Particles, Chapter 2, edited under the supervision of Soichi Muroi, CMC Shuppan (1991), The Latest Systems for Electrophotographic Development, and Development and Application of Toner Materials, Chapter 3, edited by Koichi Nakamura, Nippon Kagaku Joho K.K. (1985), and K.B.J. Barrett, Dispersion Polymerization in Organic Medium, John Wiley (1975).

In order to stabilize the particles dispersed in the nonaqueous solvent, the particles are generally dispersed together with a dispersing polymer (also sometimes referred to as a dispersion stabilizing resin hereinafter). The dispersing polymer contains repeating units soluble in the nonaqueous solvent as the main component, and a weight average molecular weight (Mw) thereof is preferably from 1×10³ to 1×10⁶, more preferably from 5×10³ to 5×10⁵.

Suitable examples of the soluble repeating units of the dispersing polymer usable in the present invention include a polymerizing component represented by the following formula

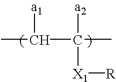

wherein X₁ represents —COO—, —OCO—or —O—; R represents an alkyl or alkenyl group having from 10 to 32 carbon atoms, preferably an alkyl or alkenyl group having from 10 to 22 carbon atoms, which may have a straight chain or branched structure and may be substituted, although the unsubstituted form is preferred (e.g., decyl, dodecyl, tridecyl, tetradecyl, hexadecyl, octadecyl, eicosanyl, docosanyl, decenyl, dodecenyl, tridecenyl, hexadecenyl, octadecenyl or linolenyl).

a¹ and a², which may be the same or different, each represents a hydrogen atom, a halogen atom (e.g., chlorine or bromine), a cyano group, an alkyl group having from 1 to 3 carbon atoms (e.g., methyl, ethyl or propyl), —COO—Z₁ or —CH₂COO—Z₁ [wherein Z₁, represents a hydrocarbon group having not more than 22 carbon atoms which may be substituted (such as an alkyl, alkenyl, aralkyl, alicyclic or aryl group) including preferably an unsubstituted or substituted alkyl group having from 1 to 22 carbon atoms (e.g., methyl, ethyl, propyl, butyl, hexyl, heptyl, octyl, nonyl, decyl, dodecyl, tridecyl, tetradecyl, hexadecyl, octadecyl, eicosanyl, docosanyl, 2-chloroethyl, 2-bromoethyl, 2-cyanoethyl, 2-methoxycarbonylethyl, 2-methoxyethy or 3-bromopropyl), an unsubstituted or substituted alkenyl group having from 4 to 18 carbon atoms (e.g., 2-methyl-1-propenyl, 2-butenyl, 2-pentenyl, 3-methyl-2-pentenyl, 1-pentenyl, 1-hexenyl, 2-hexenyl, 4-methyl-2-hexenyl, decenyl, dodecenyl, tridecenyl, hexadecenyl, octadecenyl or linolenyl), an unsubstituted or substituted aralkyl group having from 7 to 12 carbon atoms (e.g., benzyl, phenetyl, 3-phenylpropyl, naphthylmethyl, 2-naphthylethyl, chlorobenzyl, bromobenzyl, methylbenzyl, ethylbenzyl, methoxybenzyl, dimethylbenzyl or dimethoxybenzyl), an unsubstituted or substituted alicyclic group having from 5 to 8 carbon atoms (e.g., cyclohexyl, 2-cyclohexylethyl or 2-cyclopentylethyl) and an unsubstituted or substituted aromatic group having from 6 to 12 carbon atoms (e.g., phenyl, naphthyl, tolyl, xylyl, propylphenyl, butylphenyl, octylphenyl, dodecylphenyl, methoxyphenyl, ethoxyphenyl, butoxyphenyl, decyloxyphenyl, chlorophenyl, dichlorophenyl, bromophenyl, cyanophenyl, acetylphenyl, methoxycarbonylphenyl, ethoxycarbonylphenyl, butoxycarbonylphenyl, acetamidophenyl, propionamidophenyl or dodecyloylamidophenyl)].

In addition to the repeating units represented by formula (I), the dispersing polymer may contain other repeating units as copolymerizing components. The copolymerizing components may be derived from any monomers as long as they can be copolymerized with the monomers corresponding to the repeating units of formula (I).

The suitable proportion of the repeating unit represented by formula (I) in the dispersing polymer is preferably at least 50% by weight, more preferably at least 60% by weight.

The suitable examples of the dispersing polymer include those described, e.g., in JP-A-10-204354, JP-A-10-204356, JP-A-10-259336, JP-A-10-306244, JP-A-10-316917, JP-A-10-316920 and JP-B-6-40229.

Specific examples of the dispersing polymer include Dispersion Stabilizing Resin (Q-1) used in Examples described hereinafter and commercially available products, e.g., Sorprene 1205 manufactured by Asahi Chemical Industry Co., Ltd.

In preparing the resin (P) particles in the state of a dispersion (latex), it is preferred that the dispersing polymer be added prior to the polymerization.

When a dispersing polymer is used, the proportion of the dispersing polymer to the resin (P) particles is from about 1 to about 50% by weight.

In the oil-based ink employed in the present invention, it is desirable that the dispersed resin particles and colored particles (the particles of coloring material) be electroscopic particles charged positively or negatively.

In order to impart electroscopicity to those particles, wet developer technology for electrostatic photography can be appropriately utilized. Specifically, electroscopicity can be imparted to the particles by using electroscopic materials, for example, charge control agents and other additives as described, e.g., in The Latest Systems for Electrophotographic Development, and Development and Application of Toner Materials, pp. 139-148, described above, The Fundamentals and Applications of Electrophotographic Techniques, edited by Electrophotographic Society, pp. 497-505, Corona Co. (1988), and Yuji Harasaki, Electrophotography, Vol. 16 (No.2), p. 44 (1977).

In addition, details of those materials are described, e.g., in British Patents 893,429, 934,038 and 1,122,397, U.S. Pat. Nos. 3,900,412 and 4,606,989, JP-A-60-179751, JP-A-60-185963 and JP-A-2-13965.

The charge control agent as described above is preferably used in an amount of from 0.001 to 1.0 parts by weight per 1,000 parts by weight of dispersing medium as a carrier liquid. Although, various kinds of additives can be further added, the total amount of additives has an upper limit because it is restricted by the electrical resistance allowable for the oil-based ink used in the present invention. More specifically, if the ink has an electrical specific resistance of lower than 10⁹ Ω-cm under the condition that the dispersed particles are removed from the ink, the formation of a continuous-gradation image having good quality may become difficult. Therefore, it is desirable that the amount of each additive added be controlled within the above described limitation.

According to the present invention, a printing plate capable of providing a large number of prints having clear images is obtained. Further, a printing plate of high image quality is directly formed corresponding to digital image data in a stable manner, making it possible to conduct lithographic printing at a low cost and a high speed.

The present invention will be described in greater detail with reference to the following examples, but the present invention should not be construed as being limited thereto.

An example of a preparation of resin particles (PL) suitable for the oil-based ink used in the present invention will be described below.

### Preparation Example 1

### Preparation of Resin Particle (PL-1)

A mixed solution of 10 g of Dispersion Stabilizing Resin (Q-1) having the structure illustrated below, 100 g of vinyl acetate, and 384 g of Isopar H was heated to a temperature of 70° C. under nitrogen gas stream with stirring. To the solution was added 0.8 g of 2,2′-azobis(isovaleronitrile) (abbreviated as A.I.V.N.) as a polymerization initiator, followed by reacting for three hours. Twenty minutes after the addition of the polymerization initiator, the reaction mixture became white turbid, and the reaction temperature rose to 88° C. Further, 0.5 g of the above-described polymerization initiator was added to the reaction mixture, and the reaction was carried out for two hours. Then, the temperature of the reaction mixture was raised to 100° C., and stirred for two hours to remove the unreacted vinyl acetate by distillation. After cooling, the reaction mixture was passed through a nylon cloth of 200-mesh to obtain a white dispersion. In the polymerization process, the polymerization rate was 90%. The white dispersion obtained was a latex of good monodispersity having an average particle diameter of 0.23 μm. The average particle diameter was measured by CAPA-500 (manufactured by Horiba Ltd.).

Dispersion Stabilizing Resin (Q-1)

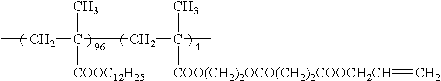

Mw: 5×10⁴ (composition ratio: by weight)

A portion of the above-described white dispersion was centrifuged at a rotation of 1×10⁴ r.p.m. for 60 minutes and the thus-precipitated resin particles were collected and dried. The weight average molecular weight (Mw) of the resin particles was 2×10⁵ (a GPC value in terms of polystyrene) and the glass transition temperature (Tg) thereof was 38° C.

### EXAMPLE 1

Oil-based ink was prepared in the following manner.

Oil-Based Ink (IK-1)

In a paint shaker (manufactured by Toyo Seiki K.K.), 10 g of copolymer of dodecyl methacrylate and acrylic acid (copolymerization ratio: 95/5 by weight), 10 g of nigrosine and 30 g of Shellsol 71 were placed together with glass beads, and the mixture was dispersed for four hours to prepare a fine dispersion of nigrosine.

A mixture of 60 g (as a solid basis) of Resin Particles (PL-1) prepared in Preparation Example 1, 2.5 g of the above-described dispersion of nigrosine, 15 g of tetradecyl alcohol (FOC-1400 manufactured by Nissan Chemical Industries, Ltd.) and 0.08 g of copolymer of octadecene and maleic acid monooctadecylamide was diluted with one liter of Isopar G, thereby preparing oil-based black ink.

An ink tank of an ink jet recording device 2 of a plate-making apparatus (see FIG. 1 and FIG. 3) was filled with 2 liters of Oil-Based Ink (IK-1). A 900 dpi 64-channel multiple-channel head as shown in FIG. 4 was used as an ejection head. A drop-in type heater and stirring blades were installed for controlling the ink temperature in the ink tank. The ink temperature was set at 30° C., and temperature control was carried out with a thermostat while rotating the stirring blades at 30 r.p.m. Rotation of the stirring blades was also utilized for preventing precipitation and aggregation. Further, a portion of the ink flow course was made transparent, which portion was arranged between a light emission diode (LED) and a light detector. In accordance with output signals from the light detector, concentration control of the ink was carried out by feeding diluent for the ink (Isopar G) or concentrated ink (the solid concentration of which was adjusted to twice that of Oil-Based Ink (IK-1)).

An aluminum plate having a thickness of 0.12 mm which had been subjected to graining and anodizing treatment was used as a printing plate precursor. The printing plate precursor was brought into close contact with a drum of the plate-making apparatus using a mechanical device for gripping a head and end portion of the printing plate precursor attached to the drum. Dust on the printing plate precursor surface was removed by air-pump suction. Then, the ejection head was moved close to the printing plate precursor until it reached the recording position. Image data for plate-making was transmitted to an arithmetic and control unit. While rotating the drum and moving the 64-channel ejection head, oil-based ink was ejected from the ejection head onto the aluminum printing plate precursor, thereby forming an image on the printing plate precursor. The ejection electrode of the ejection head had a tip width of 10 μm, and the distance between the head and the printing plate precursor was kept at 1 mm by utilizing output from an optically gap-detecting device. A voltage of 2.5 kV was always applied as a bias voltage, and a pulse voltage of 500 V was further superimposed for each ejection of ink. The duration of pulse voltage was changed stepwise from 0.2 millisecond to 0.05 millisecond in 256 steps, thereby changing the dot area for recording.

The image formed on the printing plate precursor had no defects due to dust, and deterioration of image quality due to a change in dot size was not observed at all even when the ambient temperature varied during the plate-making procedure and the number of printing plates prepared with the apparatus was increased. In other words, satisfactory plate-making was accomplished.

The image formed on the printing plate precursor was hardened by heating with a xenon flash fixing device (made by Ushio Inc.) under a luminous intensity of 200 J/pulse, thereby preparing a printing plate. Then, the ink jet recording device was moved away together with the subsidiary scanner from the position close to the drum and kept apart at a distance of 50 mm from the drum for the purpose of protecting the ejection head. Then, the printing plate was released from the plate-making apparatus and mounted on a plate cylinder of a printing machine (Oliver 266EPZ made by Sakurai Graphic Systems Co., Ltd.) to perform printing.

The print after printing 10,000 sheets had a very clear image without the occurrence of missing, fading or sharpening of the printed image.

After the completion of plate-making, the ejection head was cleaned by supplying Isopar G to the head and dripping the Isoper G from the opening of the head for 10 minutes. Then, the head was stored in a cover filled with vapor of Isopar G. By this treatment, a printing plate capable of providing prints of good quality was prepared after the lapse of three months without any other work for maintenance.

### EXAMPLE 2

A 600 dpi full-line ejection head of the type as shown in FIG. 6 was installed in a plate-making apparatus as shown in FIG. 2. A circulatory pump was employed for circulation of the ink. One ink reservoir was arranged between the pump and the ink flow-in course of the ejection head, and a second ink reservoir was arranged between the ink recovery course of the ejection head and the ink tank. The ink was circulated by the difference in hydrostatic pressure between those reservoirs in addition to the action of the circulatory pump. Also, a combination of the circulatory pump with a heater was used for controlling the ink temperature, and the ink temperature was set at 35° C. and controlled with a thermostat. The circulatory pump was further used as stirrer for preventing precipitation and aggregation. The ink flow course was provided with a conductance measuring device, and according to output signals from the device, concentration control of the ink was carried out by diluting the ink or feeding concentrated ink. An aluminum plate same as described in Example 1 was used as a printing plate precursor, and firmly fixed to a drum of the plate-making apparatus in the same manner as in Example 1. Dust on the printing plate precursor surface was removed with a rotating brush made of nylon. Then, the image data for plate-making was transmitted to an arithmetic and control unit. Recording was carried out by ejecting the oil-based ink from the full-line head onto the aluminum printing plate precursor while transporting the printing plate precursor with capstan rollers to form an image on the printing plate precursor. The image formed on the printing plate precursor had no defects due to dust, and absolutely no deterioration of image quality due to changes in dot size was observed, even when the ambient temperature varied during the plate-making procedure and the number of printing plates prepared by the apparatus was increased. In other words, satisfactory plate-making was accomplished.

The image formed on the printing plate was then hardened by heating with a heated roller (silicone rubber roller sealed with Teflon having a 300 W halogen lamp incorporated therein) under a pressure of 3 kgf/cm² (29.4 N/cm²), thereby preparing a printing plate.

Using the printing plate thus obtained, printing was performed in the same manner as in Example 1. As a result, the print obtained had a very clear image without the occurrence of missing, fading or sharpening of image even after printing 10,000 sheets. After the completion of plate-making, the ejection head was cleaned by circulating Isopar G therethrough and then bringing nonwoven fabric impregnated with Isopar G into contract with the tip of the head. By this treatment, a printing plate capable of providing prints of good quality was prepared after the lapse of three months without any other work for maintenance.

Further, the same procedure as described above was carried out using a 600 dpi full-line ejection head of the type as shown in FIG. 8 or FIG. 10 in place of the 600 dpi full-line ejection head of the type as shown in FIG. 6 employed above. Good results similar to those described above were obtained in the respective cases.

### EXAMPLE 3

The same procedure as in Example 1 was performed, except that the aluminum printing plate precursor was replaced with a printing plate precursor provided with an image-receiving layer capable of being rendered hydrophilic upon an oil-desensitizing treatment described below, the non-image area of the printing plate prepared was rendered hydrophilic using a plate surface oil-desensitizing device, the conductive layer of the printing plate precursor was grounded by contact with a conductive leaf spring (made of phosphor bronze) during the recording operation, and fixing was carried out by exposing the printing plate precursor to hot air.

Wood-free paper having a basis weight of 100 g/m² was used as a substrate and, on both sides of the substrate, a polyethylene film was laminated in a thickness of 20 μm to form a water-resistant paper support. On one side of the thus-prepared paper support, a coating for conductive layer having the following composition was coated in a dry coating amount of 10 g/m² to form a conductive layer and further thereon Dispersion A prepared in the manner indicated below was coated in a dry coating amount of 15 g/m² to form an image-receiving layer, thereby preparing a printing plate precursor.

Coating for Conductive Layer

A coating was prepared by mixing 5.4 parts of carbon black (30 % aqueous dispersion), 54.6 parts of clay (50 % aqueous dispersion), 36 parts of SBR latex (solid content: 50%, Tg: 25° C.) and 4 parts of melamine resin (solid content: 80 %, Sumirez Resin SR-613), and then adding water thereto so as to have the total solid content of 25 %.

Dispersion A

A mixture of 100 g of dry-type zinc oxide, 3 g of Binder Resin (B-1) having the structure shown below, 17 g of Binder Resin (B-2) having the structure shown below, 0.15 g of benzoic acid and 155 g of toluene was dispersed using a wet-type dispersing machine (Homogenizer made by Nippon Seiki Co., Ltd.) at 6,000 r.p.m. for 8 minutes.

Binder Resin (B-1)

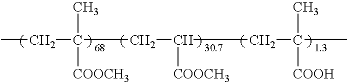

Mw: 9×10³

Binder Resin (B-2)

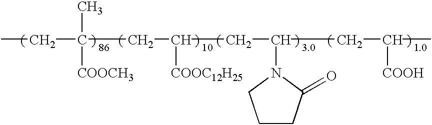

Mw: 4×10⁴ (composition ratio: by weight)

When fixing was carried out by exposing the printing plate precursor to hot air, blistering occurred on the printing plate precursor. Then, fixing was conducted by gradually and continuously increasing the electric power supply to the heater used for producing hot air or gradually and continuously decreasing the rotational speed of the drum from a high speed to a low speed while maintaining the electric power supply constant. As a result, the occurrence of blistering was prevented.

Using the printing plate thus prepared, printing was conducted in the same manner as in Example 1. The prints after printing 5,000 sheets had very clear images without the occurrence of missing, fading or sharpening of the image.

While the invention has been described in detail and with reference to specific embodiments thereof, it will be apparent to one skilled in the art that various changes and modifications can be made therein without departing from the spirit and scope thereof.

What is claimed is:

1. A plate-making method comprising the steps of forming an image based on signals of image data directly on a printing plate precursor by an ink jet recording method in which oil-based ink is ejected utilizing an electrostatic field, and fixing the image, thereby forming a printing plate.

2. The plate-making method as claimed in claim 1, wherein the oil-based ink is a dispersion comprising hydrophobic resin particles which are solid at least at ordinary temperatures dispersed in a nonaqueous solvent having an electrical specific resistance of 10⁹ Ω-cm or more and a dielectric constant of 3.5 or less.

3. A plate-making apparatus comprising:
an image former which forms an image based on signals of image data directly on a printing plate precursor; and
an image fixer which fixes the image formed by the image former to thereby prepare a printing plate;
wherein the image former comprises an ink jet recording device which ejects oil-based ink utilizing an electrostatic field from an ejection head.

4. The plate-making apparatus as claimed in claim 3, wherein the oil-based ink is a dispersion comprising hydrophobic resin particles which are solid at least at ordinary temperature dispersed in a nonaqueous solvent having an electrical specific resistance of 10⁹ Ω-cm or more and a dielectric constant of 3.5 or less.

5. The plate-making apparatus as claimed in claim 3, wherein the image former further comprises a heater comprising at least one of a heated roller, infrared lamp, halogen lamp, and xenon flash lamp.

6. The plate-making apparatus as claimed in claim 5, wherein the heater gradually increases the temperature of the printing plate precursor at the time of fixing the image.

7. The plate-making apparatus as claimed in claim 3, wherein a rotation of a drum on which the printing plate precursor is mounted effects main scanning for forming the image on the printing plate precursor.

8. The plate-making apparatus as claimed in claim 7, wherein the ejection head is moved in the axial direction of the drum to conduct subsidiary scanning for forming the image on the printing plate precursor.

9. The plate-making apparatus as claimed in claim 3, wherein transportation of the printing plate precursor by holding with at least one pair of capstan rollers effects the subsidiary scanning for forming the image on the printing plate precursor.

10. The plate-making apparatus as claimed in claim 9, wherein the ejection head is moved in the direction perpendicular to the direction of transportation of the printing plate precursor to conduct main scanning for forming the image on the printing plate precursor.

11. The plate-making apparatus as claimed in claim 7, wherein the ejection head comprises a full-line head having a length which is approximately equal to the width of the printing plate precursor.

12. The plate-making apparatus as claimed claim 3, wherein the ink jet recording device further comprises an ink supplier which supplies oil-based ink to the ejection head.

13. The plate-making apparatus as claimed in claim 12, wherein the ink jet recording device further comprises an ink recoverer which recovers oil-based ink from the ejection head in order to recirculate the ink.

14. The plate-making apparatus as claimed in claim 3, wherein the apparatus further comprises a dust remover which removes dust f rom the surf ace of the printing plate precursor.

15. The plate-making apparatus as claimed in claim 3, wherein the ink jet recording device further comprises an ink tank which holds the oil-based ink and a stirrer which stirs the oil-based ink in the ink tank.

16. The plate-making apparatus as claimed in claim 3, wherein the ink jet recording device further comprises an ink tank which holds the oil-based ink and an ink temperature controller which controls the temperature of the oil-bas ed ink in the ink tank.

17. The plate-making apparatus as claimed in claim 3, wherein the ink jet recording device further comprises an ink concentration controller which controls the concentration of the oil-based ink.

18. The plate-making apparatus as claimed in claim 3, wherein the apparatus further comprises a cleaner which cleans the ejection head.

19. The plate-making apparatus as claimed in claim 3, wherein the ejection head is comprised of an ejection electrode arranged in a slit formed between an upper unit and a lower unit, and the ejection electrode has a width of from 5 to 100 μm.

20. The plate-making apparatus as claimed in claim 3, wherein the ejection head is comprised of a firs t insulating substrate having a tapered shape, a second insulating substrate arranged to be facing toward and apart from the first insulating substrate, and a plurality of ejection electrodes, each having a width of from 5 to 100 μm, provided on the surface of the second insulating substrate facing the first insulating substrate.

21. The plate-making apparatus as claimed in claim 3, wherein the ejection head is comprised of an insulating main body having a plurality of ink grooves cut perpendicularly to the edge thereof and ejection electrodes provided in respective ones of the grooves.

22. The plate-making apparatus as claimed in claim 3, wherein the ejection head is comprised of a pair of nearly rectangular plate-shaped insulating support members, each having in one surface thereof a plurality of groves extending parallel to one another and an ejection electrode formed in each groove, arranged together so that the non-grooved surfaces thereof are brought into contact with one another such that grooves formed in one of the pair of support members are aligned with corresponding grooves in the other of the pair of support members.

23. The plate-making apparatus as claimed in claim 9, wherein the ejection head comprises a full-line head having a length which is approximately equal to the width of the printing plate precursor.
